(19) United States
(12) Patent Application Publication
(10) Pub. No.: US 2026/0116720 A1
(43) Pub. Date: Apr. 30, 2026

(54) FORKLIFT ATTACHMENT AND METHOD OF USE

(71) Applicant: Antonio JIMENEZ, San Diego, CA (US)

(72) Inventor: Antonio JIMENEZ, San Diego, CA (US)

(21) Appl. No.: 18/930,835

(22) Filed: Oct. 29, 2024

(51) Int. Cl. B66F 9/12; B65F 9/00; B66F 9/075

(52) U.S. Cl. CPC B66F 9/12; B65F 9/00; B66F 9/07504

(57) ABSTRACT

A forklift attachment for a forklift for dumping trash from a trash buggy, the trash buggy including a trash receiver supported by a wheel assembly, the forklift attachment comprising fork receivers; a platform supported by the fork receivers and including one or more securement members configured to secure the wheel assembly of the trash buggy to the platform, wherein in a first configuration, the forklift attachment is horizontally disposed to receive and secure the trash buggy thereto via the wheel assembly and the one or more securement members, and in a second configuration, the forklift attachment is tilted forward at an angle relative to horizontal sufficient enough to cause the trash receiver to tilt forward relative to the forklift attachment and dump the trash therefrom while the trash buggy is secured to the forklift attachment via the wheel assembly and the one or more securement members.

### FIELD OF THE INVENTION

The present invention generally relates to forklift attachments.

### SUMMARY OF THE INVENTION

An aspect of the disclosure involves a variable reach fork platform attachment for dumping trash, specifically for dumping trash from a buggy/Georgia buggy in construction sites. The attachment includes two fork slot members, a curved section, and a platform made out of steel and welded together. Two slotted grates on a forklift-side of the platform are used for securing the buggy in place on the platform with securement straps. The curved section between the two fork slots is for the tires/wheels on the buggy to sit in and prevent them from rolling. The overall function/purpose of the attachment is to easily transport, load, and unload the trash/Georgia buggies with a forklift.

An aspect of present disclosure involves a forklift attachment for a forklift for dumping trash from a trash buggy, the trash buggy including a trash receiver supported by a wheel assembly, the forklift attachment comprising fork receivers; a platform supported by the fork receivers and including one or more securement members configured to secure the wheel assembly of the trash buggy to the platform, wherein in a first configuration, the forklift attachment is horizontally disposed to receive and secure the trash buggy thereto via the wheel assembly and the one or more securement members, and in a second configuration, the forklift attachment is tilted forward at an angle relative to horizontal sufficient enough to cause the trash receiver to tilt forward relative to the forklift attachment and dump the trash therefrom while the trash buggy is secured to the forklift attachment via the wheel assembly and the one or more securement members.

One or more implementations of the above aspect of the disclosure include one or more of the following: the fork receivers and the platform are made of steel and are welded together; the one or more securement members include a recessed member configured to receive one or more wheels of the wheel assembly; the one or more securement members include a slotted grate; the one or more securement members include one or more straps; and/or the one or more securement members include one or more fasteners.

Another aspect of present disclosure involves a method of using a forklift attachment for a forklift for dumping trash from a trash buggy, the trash buggy including a trash receiver supported by a wheel assembly, the forklift attachment comprising fork receivers; a platform supported by the fork receivers and including one or more securement members configured to secure the wheel assembly of the trash buggy to the platform, wherein in a first configuration, the forklift attachment is horizontally disposed to receive and secure the trash buggy thereto via the wheel assembly and the one or more securement members, and in a second configuration, the forklift attachment is tilted forward at an angle relative to horizontal sufficient enough to cause the trash receiver to tilt forward relative to the forklift attachment and dump the trash therefrom while the trash buggy is secured to the forklift attachment via the wheel assembly and the one or more securement members, the method comprising receiving forks of the forklift within the fork receivers with the one or more securement members securing the wheel assembly of the trash buggy to the platform with the trash receiving including trash and the forklift attachment horizontally disposed; and dumping trash from the trash buggy by tilting trash receiver forward relative to the forklift attachment while the trash buggy is secured to the forklift attachment via the wheel assembly and the one or more securement members caused by the forklift attachment being tilted forward via the forks of the forklift.

One or more implementations of the immediately above aspect of the disclosure include one or more of the following: the fork receivers and the platform are made of steel and are welded together; the one or more securement members include a recessed member, and the method further comprising receiving one or more wheels of the wheel assembly in the recessed member; the one or more securement members include a slotted grate, and the method further comprising securing one or more wheels of the wheel assembly to the forklift attachment via the slotted grate; the one or more securement members include one or more straps, and the method further comprising securing one or more wheels of the wheel assembly to the forklift attachment via the one or more straps; and/or the one or more securement members include one or more fasteners, and the method further comprising securing one or more wheels of the wheel assembly to the forklift attachment via the one or more fasteners.

### BRIEF DESCRIPTION OF THE DRAWINGS

In order to describe the manner in which the present disclosure can be implemented, a more particular description will be rendered by reference to specific implementations thereof which are illustrated in the appended drawings. For better understanding, the like elements have been designated by like reference numbers throughout the various accompanying figures. Understanding that these drawings depict only typical implementations of the invention and are not therefore to be considered to be limiting of its scope, the invention will be described and explained with additional specificity and detail through the use of the accompanying drawings in which:

FIG. 1 illustrates a perspective view of a forklift attachment with a trash buggy secured thereon in an upright position and the forklift attachment horizontally disposed.

FIG. 2 illustrates another perspective view of the forklift attachment and trash buggy of FIG. 1, but with the trash buggy shown tipped forward to dump trash.

FIG. 3 illustrates a side view of the forklift attachment of FIG. 1 with the trash buggy secured thereon in an upright position, and with the forklift attachment horizontally disposed and received on forks of a forklift and with an adjacent dumpster/trash bin.

FIG. 4 illustrates a side view similar to FIG. 3, but shows the forklift raising the forklift attachment and trash buggy adjacent to the dumpster/trash bin with the forklift attachment horizontally disposed.

FIG. 5 illustrates a side view similar to FIG. 4, but shows the forklift tilting the forklift attachment forward at an angle relative to horizontal sufficient enough to cause the trash buggy to tilt forward, dumping trash therefrom, into the dumpster/trash bin.

### DETAILED DESCRIPTION OF PREFERRED EMBODIMENTS

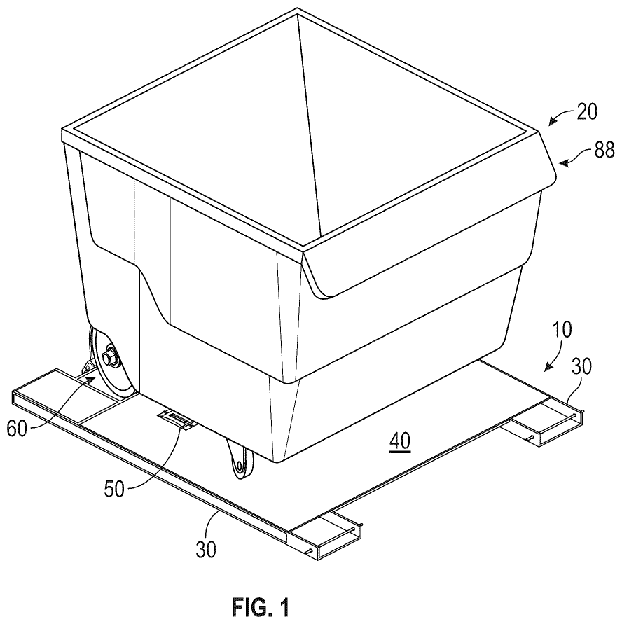

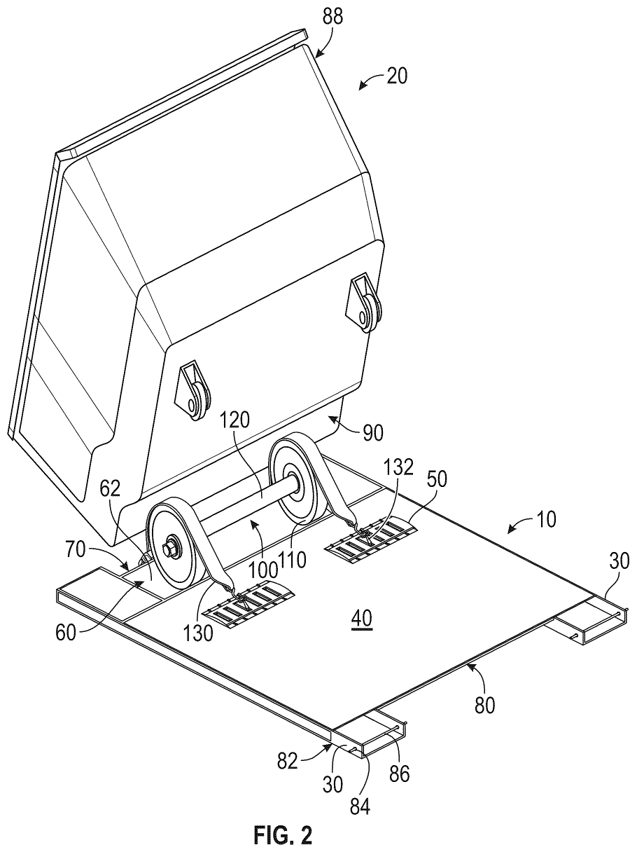

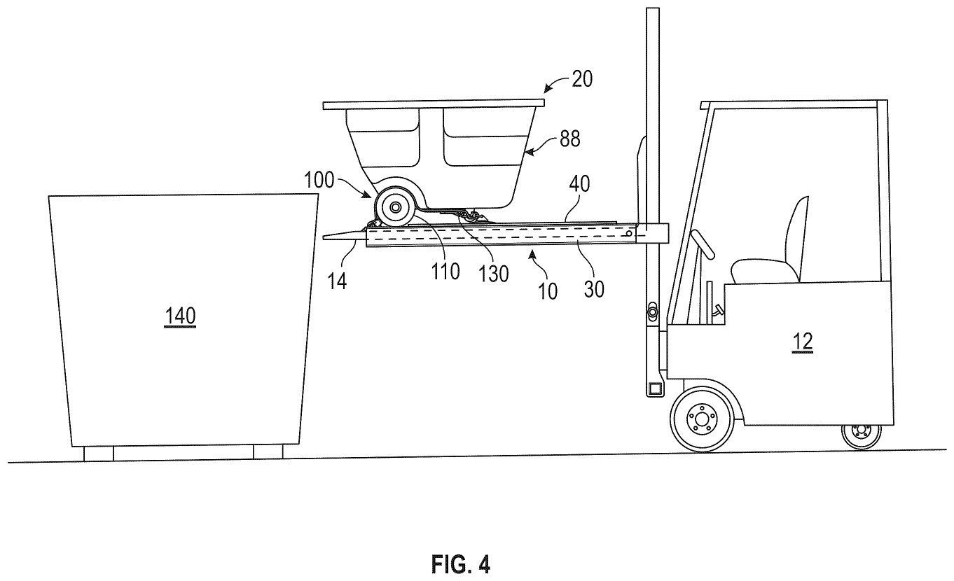

In this disclosure, as illustrated in FIGS. 1-5, specific terminology is employed for the sake of clarity. The invention as claimed in this application, however, is not intended to be limited to specific terminology so selected, and it is to be understood that each specific element includes all technical equivalents that operate in a similar manner to accomplish similar functions.

Reference will now be made to the figures to describe various aspects of example embodiments of the disclosure. FIGS. 1-5 depict a forklift attachment 10 for a forklift 12. As used herein, a “forklift” includes a Pettibone® handler (“pettibone”), a rough terrain forklift, a telescopic handler, a counterbalance forklift, a reach truck, an order picker, a side loader, an electric forklift, a pallet jack forklift, and/or other lift trucks/industrial trucks including forks for lifting a load. The forklift 12 includes adjustable angle forks 14 for dumping trash from a trash buggy (e.g., Georgia buggy) 20 secured to the forklift attachment 10. The forklift attachment 10 includes elongated rectangular tubular fork receivers 30, a platform 40 a supported by the fork receivers 30, slotted grate 50, recessed member 60 with recess/trough 62, front end 70, and rear end 80. The fork receivers 30, platform 40, slotted grate 50, recessed member 60, front end 70, and rear end 80 are made of steel and welded together. Rear portions 82 of the fork receivers 30 include holes 84 that receive pins 86 that prevent the forklift attachment 10 from sliding off of the forks 14.

The trash buggy 20 includes a trash receiver 88 with an underside 90 that the wheel assembly 100 supports and is coupled to. The wheel assembly 100 includes wheels 110 and shaft 120. The wheels 110 sit in the recessed member 60, preventing the wheels from rolling.

Securement straps 130 are used to secure the wheels 110 of the wheel assembly 100 within the recessed member 60 and to the forklift attachment 10. The securement straps 130 may go over the wheels 110 and be coupled to the front end 70 via fasteners and the slotted grate 50 via fasteners 132 to hold the trash buggy 20 to the forklift attachment 10. The recessed member 60, securement straps 130, slotted grate 50, and fasteners serve as one or more securement members configured to secure the wheel assembly 100 of the trash buggy 20 to the platform 40.

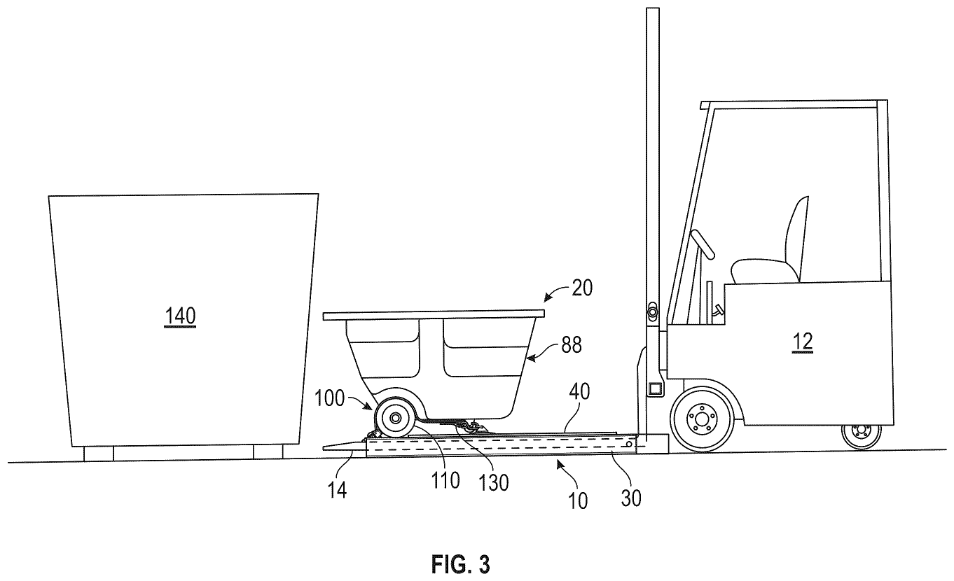

In a first configuration (FIGS. 1, 3), the forklift attachment 10 is horizontally disposed to receive and secure the trash buggy 20 thereto via the wheel assembly 100 and the one or more securement members.

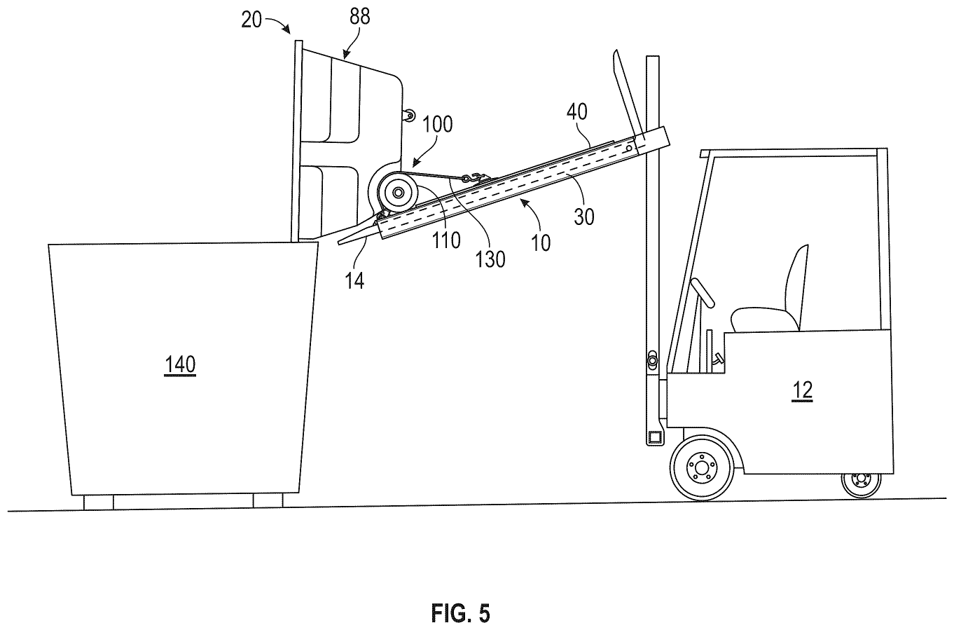

In a second configuration (FIG. 5), the forklift attachment 10 is tilted forward at an angle relative to horizontal sufficient enough to cause the trash receiver 88 to tilt forward relative to the forklift attachment 10 and dump the trash therefrom while the trash buggy 20 is secured to the forklift attachment 10 via the wheel assembly 100 and the one or more securement members.

With reference to FIGS. 3-5, in use, the forklift attachment 10 dumps trash from the trash buggy 20 by receiving the forks 14 of the forklift 12 within the fork receivers 30 with the one or more securement members securing the wheel assembly 100 of the trash buggy 20 to the platform 40 with the trash receiver 88 including trash in an upright position and the forklift attachment 10 horizontally disposed. The forklift 12 lifts the forklift attachment 10 using the forks 14 and moves adjacent to an area (e.g., dumpster 140) to dump the trash. Next, dumping trash from the trash buggy 20 (e.g., into the dumpster 140) occurs by tilting trash receiver 88 forward/up relative to the forklift attachment 10 while the trash buggy 20 is secured to the forklift attachment 10 via the wheel assembly 100 and the one or more securement members by tilting the forklift attachment 10 forward via the forks 14 of the forklift 12.

The forklift attachment 10 allows one to easily transport, load, and unload the trash/Georgia buggies, especially at a construction site, using a forklift 12.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

I claim:

1. A forklift attachment for a forklift for dumping trash from a trash buggy, the trash buggy including a trash receiver supported by a wheel assembly, the forklift attachment comprising:
fork receivers;
a platform supported by the fork receivers and including one or more securement members configured to secure the wheel assembly of the trash buggy to the platform, wherein
in a first configuration, the forklift attachment is horizontally disposed to receive and secure the trash buggy thereto via the wheel assembly and the one or more securement members, and
in a second configuration, the forklift attachment is tilted forward at an angle relative to horizontal sufficient enough to cause the trash receiver to tilt forward relative to the forklift attachment and dump the trash therefrom while the trash buggy is secured to the forklift attachment via the wheel assembly and the one or more securement members.

2. The forklift attachment of claim 1, wherein the fork receivers and the platform are made of steel and are welded together.

3. The forklift attachment of claim 1, wherein the one or more securement members include a recessed member configured to receive one or more wheels of the wheel assembly.

4. The forklift attachment of claim 1, wherein the one or more securement members include a slotted grate.

5. The forklift attachment of claim 1, wherein the one or more securement members include one or more straps.

6. The forklift attachment of claim 1, wherein the one or more securement members include one or more fasteners.

7. A method of using the forklift attachment of claim 1 for dumping trash, comprising:
receiving forks of the forklift within the fork receivers with the one or more securement members securing the wheel assembly of the trash buggy to the platform with the trash receiver including trash and the forklift attachment horizontally disposed;
dumping trash from the trash buggy by tilting trash receiver forward relative to the forklift attachment while the trash buggy is secured to the forklift attachment via the wheel assembly and the one or more securement members caused by the forklift attachment being tilted forward via the forks of the forklift.

8. The method of claim 7, wherein the fork receivers and the platform are made of steel and are welded together.

9. The method of claim 7, wherein the one or more securement members include a recessed member, and the method further comprising receiving one or more wheels of the wheel assembly in the recessed member.

10. The method of claim 7, wherein the one or more securement members include a slotted grate, and the method further comprising securing one or more wheels of the wheel assembly to the forklift attachment via the slotted grate.

11. The method of claim 7, wherein the one or more securement members include one or more straps, and the method further comprising securing one or more wheels of the wheel assembly to the forklift attachment via the one or more straps.

12. The method of claim 7, wherein the one or more securement members include one or more fasteners, and the method further comprising securing one or more wheels of the wheel assembly to the forklift attachment via the one or more fasteners.
